(19) United States
(12) Patent Application Publication
(10) Pub. No.: US 2005/0218388 A1
(43) Pub. Date: Oct. 6, 2005

(54) Single-roller lower block for hoisting equipment

(76) Inventor: Karl Zacharias, Schwerte (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/012,909

(22) Filed: Dec. 15, 2004

(30) Foreign Application Priority Data
Dec. 18, 2003 (DE) 103 59 876.6-22

(51) Int. Cl. B66D 3/04

(52) U.S. Cl. 254/409

(57) ABSTRACT

The invention concerns a single-roller lower block for hoisting equipment with a deflection device (2) for a traction means, able to turn about a pivot axis (1), and a suspension (3) for a load hook (4), wherein the deflection device (2) and the suspension (3) for the load hook (4) are joined together by two essentially parallel-arranged tie bars (5a, 5b). At least one of the tie bars (5a, 5b) may form an axle (18) for the deflection device (2).

### BACKGROUND OF THE INVENTION

The invention is directed to a single-roller lower block for hoisting equipment with a deflection device for a traction means that can turn about a pivot axis and a suspension for a load hook.

Single-roller lower blocks for hoisting equipment with suspensions for load hooks are known from practical use in various configurations. From DIN 15 411 there is known a single-roller lower block, in which the load hook is mounted on a suspension that can turn about a vertical axis. The load hook suspension is fastened by two parallel tie bars to an axis on which the cable roller for the traction means is mounted. The actual load hook suspension in this configuration consists of an axle bolt joining together the two tie bars and a nut screwed onto the free end of the load hook shaft, projecting from the axle bolt. This known construction has relatively many parts.

From DE 36 01 127 C2 there is known a load suspension device, which is provided with two side plates, one of which, the so-called movable plate, can swivel about the axis of the roller, which is arranged between the two plates. The roller runs on a bearing, which is located on an axis, which extends between the outer surfaces of the two plates.

From DE 1 093 067 A there is known a corresponding roller housing, in which the roller axis is mounted in two boreholes of the housing halves.

U.S. Pat. No. 2,332,389 also discloses a roller axis, which is mounted in suitable receptacles in the two housing halves of the lower block.

Also, from GB 573,352, GB 244,180 and U.S. Pat. No. 2,649,282 it is known in similar fashion how to support the cable roller on an axis which is received in corresponding boreholes in the particular lateral housing halves.

### SUMMARY OF THE INVENTION

The present invention is directed to creating a simple construction of a single-roller lower block for hoisting equipment. This problem is solved by a single-roller lower block with the features of claim 1. Advantageous configurations of the invention are indicated in the subsidiary claims 2-25.

According to the invention, in a single-roller lower block for hoisting equipment with a deflection device for a traction means that can turn about a pivot axis and a suspension for a load hook, wherein the deflection device and the suspension for the load hook are joined together by two essentially parallel-arranged tie bars, a simple construction is achieved in that at least one of the tie bars forms an axis for the deflection device. Thus, the axis is integrated in at least one of the tie bars. In this way, for the first time one can eliminate the use of an axis as a separate part for the supporting of the deflection device. Accordingly, the construction and assembly of the lower block become more simple.

In the preferred embodiment, the two tie bars are joined by screw connections to form a lengthwise divided tie bar body. At the facing ends of the tie bars there is arranged a projection in the form of an axle stub. The projections then complement each other advantageously in the screwed together condition of the tie bars as an axle for the deflection device.

To improve the stability of the lower block, the projections of the two tie bars may lie against each other by their particular end surfaces when the tie bars are screwed together.

The joining of the tie bars into the tie bar body is easily done in that a continuous borehole extending in the lengthwise direction is arranged centrally in each of the projections, into which a screw connection is inserted.

A further reduction of structural parts is accomplished in that the two tie bars have mirror symmetry in relation to their joining plane in the screwed-together condition.

According to one embodiment of the invention, it is proposed that a receiving space be formed between the two tie bars in order to completely receive the suspension for the load hook and the two tie bars at least partly embrace the load hook suspension mounted in the receiving space. It is also proposed that the two tie bars at least partly embrace the load hook suspension mounted in the receiving space. According to one practical embodiment of the invention, the free ends of the two tie bars are directed pointing toward each other, forming undercuts to produce the receiving space. The free ends of the tie bars pointing toward each other firmly close up the intervening space between the tie bars and thus form bearing surfaces for the load hook suspension.

In the preferred embodiment, the tie bars are configured as cast metal parts. Thus, it is easy to form the projections for formation of the axles, the receiving space for the suspension, and the continuous opening for the deflection device.

### BRIEF DESCRIPTION OF THE DRAWINGS

Additional features and benefits of the invention will be evident from the corresponding drawing, which shows a sample embodiment of a single-roller lower block for hoisting equipment according to the invention.

FIG. 1 is a side elevation of a single-roller lower block according to the invention;

FIG. 2 is a sectional view taken along the lines II-II of FIG. 1;

FIG. 3 is a sectional view taken along the lines III-III of FIG. 1; and

FIG. 4 is a sectional view taken along the lines IV-IV of FIG. 1.

### DETAILED DESCRIPTION OF THE PREFERRED EMBODIMENT

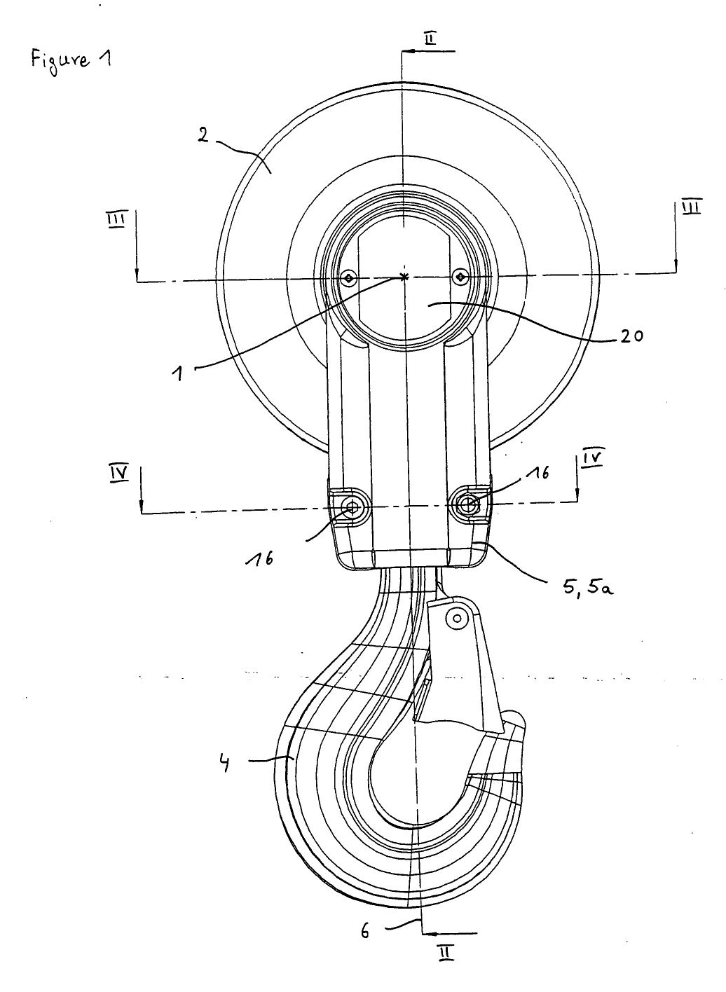

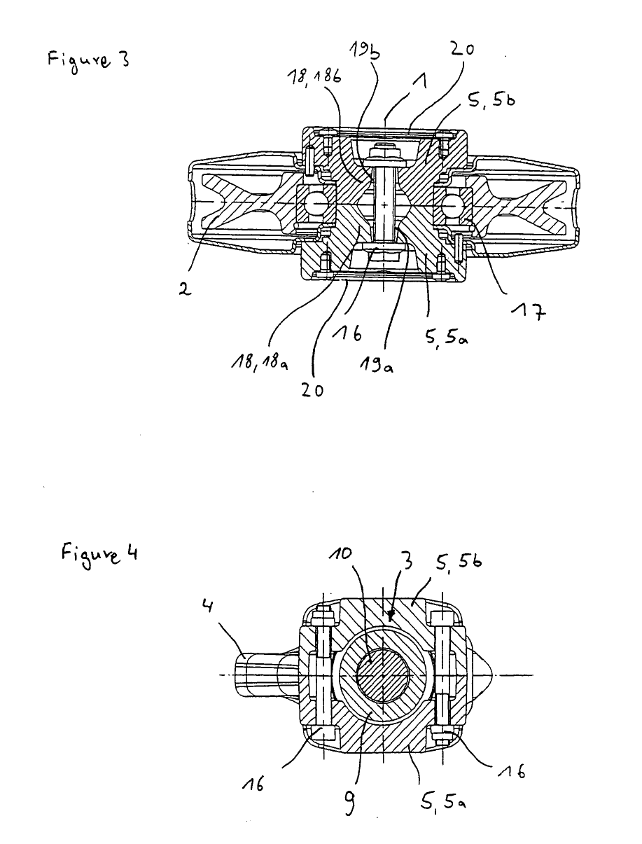

Referring now to the drawings and the illustrative embodiments depicted therein, FIGS. 1 through 4 show a single-roller lower block for hoisting equipment with a deflection device 2 for a traction device (not shown), able to rotate about a pivot axis 1, and with a suspension 3 for a load hook 4, arranged below the deflection device 2, wherein the deflection device 2 and the suspension 3 for the load hook 4 are joined together by two essentially parallel arranged tie bars 5a, 5b. The tie bars 5a, 5b in the embodiment depicted are suspended in the region of the pivot axis 1 of the deflection device 2.

Although the deflection device 2 in the embodiment depicted is fashioned as a roller for a length of cable, of course it is also possible to outfit the single-roller lower block with a chain wheel for a chain as the traction means.

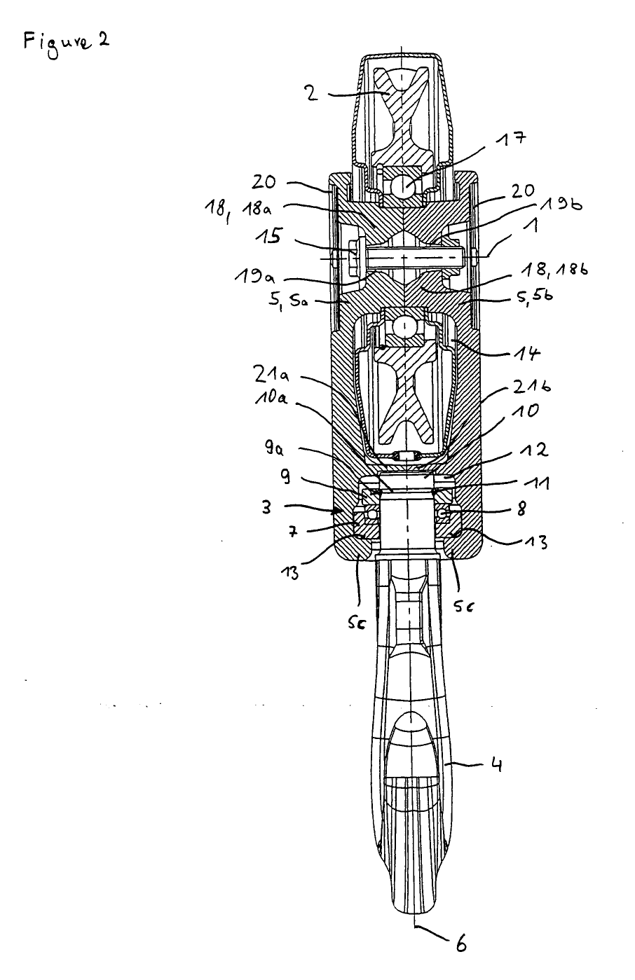

As is evident from FIG. 2, the suspension 3 for the load hook 4, which can turn about a vertical axis 6, consists of a bearing retainer 7, an axial bearing 8 configured as an axial ball bearing, and a thrust collar 9, each of them arranged in ring fashion about a shaft 10 of the load hook 4.

The fastening of the suspension 3 to the shaft 10 of the load hook 4 is done by a securing element 11, such as a snap ring, which in the installed condition engages an undercut formed as an annular groove 10a at the free end of the shaft 10, on the one hand, and is arranged in a recess 9a of the thrust ring 9, on the other hand. This construction has the advantage of enabling an especially low structural height for the bearing arrangement 6, since the free end of the shaft 10 projects only slightly beyond the upper edge of the thrust ring 9.

While in the embodiment depicted the undercut at the free end of the shaft 10 to accommodate the securing element 11 is fashioned as a circumferential annular groove 10a, it is also possible, for example, to configure the undercut for receiving the securing element 11 as a tapering of the cross section of the shaft, so that lower notch stresses occur than in the case of the annular groove 10a.

As is furthermore evident from FIG. 2, a receiving space 12 is formed between the two tie bars 5a, 5b to entirely accommodate the entire suspension 3 for the load hook 4.

In regard to the two tie bars 5a, 5b, one further notes from FIGS. 1 and 2 that these are joined together by screw connections 15, 16 into an essentially cuboid tie bar body 5. The tie bar body 5 is oriented with its lengthwise dimension vertical to the lower block during operation. The tie bars 5a, 5b forming the two lengthwise halves of the tie bar body 5 are each shell-shaped, so that when joined together, they bound the above-described receiving space 12 in the shape of a blind hole at the lower end of the tie bar body 5 and also at its middle a continuous opening 14 directed transversely to the lengthwise dimension of the tie bar body 5. This continuous opening 14 serves to lead the ring-shaped deflection device 2 through the tie bar body 5.

Another feature of this tie bar body 5 is that an axle stub-shaped projection 18a, 18b is arranged in its upper region at the adjoining inner ends of the tie bars 5a, 5b. These two projections 18a, 18b—when the tie bars 5a, 5b are screwed together—complement each other and form an axle 18 with the pivot axis 1 for the pivoted bearing of the deflection means 2. The axle 18 thus forms the bearing retainer for the inner bearing shell of a bearing 17 for the rotating deflection device 2, so that the overall number of structural parts being installed can be further reduced. The two projections 18a, 18b also bound the continuous opening 14 at the top.

Furthermore, FIG. 2 shows that the projections 18a, 18b have a central continuous borehole 19a, 19b in the direction of the pivot axis 1. These mutually aligned continuous boreholes 19a, 19b serve to receive a first screw connection 15, in order to join together the two tie bars 5a, 5b. As shown in FIG. 1, the other two screw connections 16 are arranged in the region of the receiving space 12.

Thanks to the screw connections 16 in the region of the receiving space 12 and the screw connection 15 in the region of the axle 18, the tie bars 5 are not forced apart by the traction forces transmitted via the load hook 4.

Furthermore, the tie bars 5a, 5b are drawn in at outside portions, namely, in the region of the projections 18a, 18b. In this manner, after the screw connection 15 is installed, the screw head and the nut are countersunk in relation to the outer surface of the tie bars 5a, 5b. The screw connection 15 is then covered with a cover 20 on the outside, lying in the same plane as the outside of the tie bars 5a, 5b. The tie bars 5a, 5b are also fashioned as cast metal pieces.

In the screwed-together condition of the tie bars 5a, 5b, they lie against each other in the region of the projections 18a, 18b and in the region of webs 21a, 21b at the respective planar end surfaces of the projections 18a, 18b and the webs 21a, 21b. The webs 21a, 21b bound the receiving space 12 at the top and thus also separate the receiving space 12 from the continuous opening 14 lying above it.

Thanks to the above-described configuration of the tie bar body 5, it is possible for the first time to eliminate the axle bolt familiar from the state of the art for the deflection device 2, which is now supported on the two tie bars 5a, 5b. Each of the projections 18a, 18b is part of the tie bars 5a, 5b. This achieves a simple layout of the lower block.

In order to mount the suspension 3 for the load hook 4 in the receiving space 12 with support, in the first configuration represented in FIG. 2 the free ends 5a of the tie bars 5, which form undercuts 13, are pointed toward each other so that the tie bars 5 at least partly embrace the suspension 3 for the load hook 4 mounted in the receiving space 12. As an alternative to the forming of undercuts 13 by the formed free ends 5c of the tie bars 5, it is also possible to form protrusions at the facing inner sides of the tie bars 5, against which the suspension 3 rests.

Single-roller lower blocks for hoisting equipment of such configuration are characterized by their compact and simple construction, with lower structural height at the same time.

Changes and modifications in the specifically described embodiments can be carried out without departing from the principles of the invention which is intended to be limited only by the scope of the appended claims, as interpreted according to the principles of patent law including the doctrine of equivalents.

1. A single-roller lower block for hoisting equipment, comprising:
a deflection device for a traction device, said deflection device able to turn about a pivot axis;
a suspension for a load hook;
wherein said deflection device and said suspension for the load hook are joined together by two essentially parallel-arranged tie bars, wherein at least one of said tie bars forms an axle for said deflection device.

2. The lower block of claim 1, wherein said two tie bars are joined by screw connections into a lengthwise divided tie bar body, a projection in the form of an axle stub is arranged at each of the facing sides of said tie bars, and said projections complement each other when said tie bars are screwed together to form an axle for said deflection device.

3. The lower block of claim 2, wherein said projections of said two tie bars rest against each other by their respective end surfaces when said tie bars are screwed together.

4. The lower block of claim 3 including a continuous borehole extending in the lengthwise direction centrally in each of said projections in which a screw connection is inserted for connecting said tie bars into said tie bar body.

5. The lower block of claim 4, wherein said two tie bars have mirror symmetry in relation to their joining plane in the screwed-together condition.

6. The lower block of claim 5 including a receiving space that is configured between said two tie bars for the complete accommodation of said suspension for said load hook and said two tie bars at least partly embrace said suspension of said load hook mounted in said receiving space.

7. The lower block of claim 6, wherein said free ends of said two tie bars point toward each other forming undercuts to form said receiving space.

8. The lower block of claim 7, wherein said tie bars are cast metal pieces.

9. The lower block of claim 2 including a continuous borehole extending in the lengthwise direction centrally in each of said projections in which a screw connection is inserted for connecting said tie bars into said tie bar body.

10. The lower block of claim 9, wherein said two tie bars have mirror symmetry in relation to their joining plane in the screwed-together condition.

11. The lower block of claim 10 including a receiving space that is configured between said two tie bars for the complete accommodation of said suspension for said load hook and said two tie bars at least partly embrace said suspension of said load hook mounted in said receiving space.

12. The lower block of claim 11, wherein said free ends of said two tie bars point toward each other forming undercuts to form said receiving space.

13. The lower block of claim 12, wherein said tie bars are cast metal pieces.

14. The lower block of claim 3, wherein said two tie bars have mirror symmetry in relation to their joining plane in the screwed-together condition.

15. The lower block of claim 2, wherein said two tie bars have mirror symmetry in relation to their joining plane in the screwed-together condition.

16. The lower block of claim 1, wherein said two tie bars have mirror symmetry in relation to their joining plane in the screwed-together condition.

17. The lower block of claim 4 including a receiving space that is configured between said two tie bars for the complete accommodation of said suspension for said load hook and said two tie bars at least partly embrace said suspension of said load hook mounted in said receiving space.

18. The lower block of claim 17, wherein said free ends of said two tie bars point toward each other forming undercuts to form said receiving space.

19. The lower block of claim 3 including a receiving space that is configured between said two tie bars for the complete accommodation of said suspension for said load hook and said two tie bars at least partly embrace said suspension of said load hook mounted in said receiving space.

20. The lower block of claim 19, wherein said free ends of said two tie bars point toward each other forming undercuts to form said receiving space.

21. The lower block of claim 2 including a receiving space that is configured between said two tie bars for the complete accommodation of said suspension for said load hook and said two tie bars at least partly embrace said suspension of said load hook mounted in said receiving space.

22. The lower block of claim 21, wherein said free ends of said two tie bars point toward each other forming undercuts to form said receiving space.

23. The lower block of claim 1 including a receiving space that is configured between said two tie bars for the complete accommodation of said suspension for said load hook and said two tie bars at least partly embrace said suspension of said load hook mounted in said receiving space.

24. The lower block of claim 23, wherein said free ends of said two tie bars point toward each other forming undercuts to form said receiving space.

25. The lower block of claim 1, wherein said tie bars are cast metal pieces.
